(19) United States
(12) Patent Application Publication
(10) Pub. No.: US 2026/0295910 A1
(43) Pub. Date: Oct. 1, 2026

(54) RECYCLING WASTE AIR FILTRATION WASTE TO MAKE GLASS-REINFORCED THERMOPLASTIC COMPOSITES

(71) Applicant: JOHNS MANVILLE, Denver, CO (US)

(72) Inventors: Christopher James Griffin, Aurora, CO (US); Scott Coons, Castle Rock, CO (US); Alexander Uckert, Wertheim Baden-Wurttemberg (DE); Jan-Roel van der Sluis, Wertheim am Main (DE); Jason Young Yu, Highlands Ranch, CO (US)

(21) Appl. No.: 19/090,561

(22) Filed: Mar. 26, 2025

(51) Int. Cl. B29C 45/00; B29B 9/06; B29B 17/00; B29B 17/04; B29K 101/12; B29K 105/26; B29K 309/08

(52) U.S. Cl. CPC B29C 45/0005; B29B 9/06; B29B 2017/0015; B29B 17/0412; B29B 2017/042; B29K 2101/12; B29K 2105/26; B29K 2309/08

(57) ABSTRACT

Embodiments of the present technology may encompass methods of recycling air filtration waste. The methods may include supplying air filtration waste to a recycling unit. The air filtration waste may include a first thermoplastic material and glass. The methods may include supplying a second thermoplastic material to the recycling unit. The methods may include forming a plurality of composite pellets from the air filtration waste and the second thermoplastic material using the recycling unit. The plurality of composite pellets may include a mixture of the first thermoplastic material, the second thermoplastic material, and the glass.

### BACKGROUND OF THE INVENTION

During the production of air filters, startup and shutdown processes, trimming, out of specification product, and other features of the manufacturing process generate waste material. Due to the combination of materials present in the waste material, such waste material is sent to landfills. Additionally, once installed air filters reach their end of life, these filters are sent to landfills. Such processes result in excess waste of polymeric and glass materials. Therefore, improvements in the handling of such materials are desired.

### BRIEF SUMMARY OF THE INVENTION

Embodiments of the present technology may encompass methods of recycling air filtration waste. The methods may include supplying air filtration waste to a recycling unit. The air filtration waste may include a first thermoplastic material and glass. The methods may include supplying a second thermoplastic material to the recycling unit. The methods may include forming a plurality of composite pellets from the air filtration waste and the second thermoplastic material using the recycling unit. The plurality of composite pellets may include a mixture of the first thermoplastic material, the second thermoplastic material, and the glass.

In some embodiments, the air filtration waste may include one or both of used air filters and waste from a process for fabricating filters. The second thermoplastic material may include recycled thermoplastic material. The second thermoplastic material may include a plurality of pellets formed from the second thermoplastic material. The first thermoplastic material and the second thermoplastic material may be a same material. The methods may include adding one or more additives to the recycling unit. The plurality of composite pellets may further include the one or more additives. The one or more additives may include at least one of an impact enhancer, UV modifier, or de-gassing agent.

Some embodiments of the present technology may encompass methods of recycling air filtration waste. The methods may include supplying air filtration waste to a recycling unit. The air filtration waste may include a first thermoplastic material and glass. The methods may include supplying a second thermoplastic material to the recycling unit. The methods may include forming a plurality of composite pellets from the air filtration waste and the second thermoplastic material using the recycling unit. The plurality of composite pellets may include a mixture of the first thermoplastic material, the second thermoplastic material, and the glass. The methods may include forming a recycled product using at least some of the plurality of composite pellets.

In some embodiments, the methods may include determining one or more desired properties of the plurality of composite pellets. The methods may include adjusting amount of the second thermoplastic material supplied to the recycling unit based on the one or more desired properties. The recycled product may include a frame of an air filter. Forming the recycled product may include using injection molding to form the frame from the at least some of the plurality of composite pellets. The methods may include cleaning the air filtration waste prior to forming the plurality of composite pellets. The air filtration waste may form between 40% and 60% by weight of materials supplied to the recycling unit. The second thermoplastic material may form between 40% and 60% by weight of materials supplied to the recycling unit. The plurality of composite pellets may include between 20% and 40% by weight of the glass.

Some embodiments of the present technology may encompass methods of recycling air filtration waste. The methods may include supplying air filtration waste to a recycling unit. The air filtration waste may include a first thermoplastic material and glass. The methods may include supplying a second thermoplastic material to the recycling unit. The methods may include forming a plurality of composite pellets from the air filtration waste and the second thermoplastic material using the recycling unit. The plurality of composite pellets may include a mixture of the first thermoplastic material, the second thermoplastic material, and the glass. Forming the plurality of composite pellets may include breaking down the plurality of air filtration media into pieces of air filtration waste, melting the pieces of air filtration waste and the second thermoplastic material to form a melted composite material, extruding the melted composite material to form a plurality of strands of composite material, and chopping the plurality of strands of composite material to form the plurality of composite pellets.

In some embodiments, the methods may include supplying a glass material to the recycling unit. The glass from the air filtration waste and the glass material may be a same form of glass. The glass material may include one or both of waste chopped glass and glass fibers. The first thermoplastic material and the second thermoplastic material may be different materials. The recycling unit may include a compounder and a pelletizer.

### BRIEF DESCRIPTION OF THE DRAWINGS

A further understanding of the nature and advantages of various embodiments may be realized by reference to the following figures. In the appended figures, similar components or features may have the same reference label. If only the first reference label is used in the specification, the description is applicable to any one of the similar components having the same first reference label irrespective of the second reference label.

FIG. 1 illustrates a block diagram for a system for recycling air filtration waste according to embodiments of the present invention.

FIG. 2 is a flowchart of a method of recycling air filtration waste according to embodiments of the present invention.

FIG. 3 is a perspective view of an air filtration waste according to embodiments of the present invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present technology are directed to systems and methods for recycling waste materials associated with the use and production of air filters. The systems and methods described herein may enable the glass and polymeric materials from air filters to be recycled and reused in the production of additional products, such as injection molded components. In a particular application, the air filters may be recycled into frames and/or other components for new air filters, however it will be appreciated that any product formed from a combination of thermoplastic material and glass may be produced using the recycling techniques produced herein.

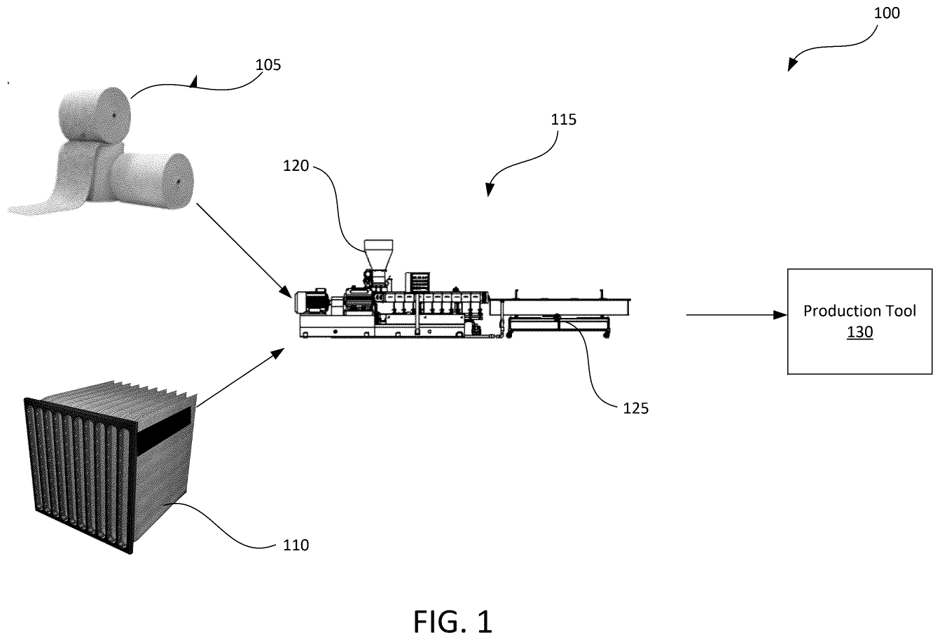

FIG. 1 illustrates a system 100 for recycling air filtration waste according to embodiments of the present invention. The system 100 may include one or more sources 105 of waste from manufacturing air filters. For example, the sources 105 may include manufacturers of air filters or components thereof, such as air filtration media of the air filters. The waste from air filters may include, for example, trimmed material from edges or other regions of the air filtration media. Such material may be trimmed from the air filtration media to create clean edges and/or to form sheets of a final size. Trim waste may be from a manufacturer of the air filtration media and/or from a manufacturer of the final air filter, who may trim air filtration media from another manufacturer to fit filter frames used during assembly of the air filters. Other waste from the production of air filters may include air filtration media material formed at the beginning and/or end of a run and/or during product changeovers, as such material may not meet the desired specifications of a given product line. Similarly, waste may include finished materials that are out of predetermined specifications and are therefore unusable for their intended applications. While shown with a single source 105, it will be appreciated that the system 100 may include any number of sources 105 in various embodiments.

The system 100 may include one or more sources 110 of end of life or other used air filters that have since been replaced and discarded. Such sources 110 may include, for example, recycling and/or collection centers where end users may turn in discarded air filters. The sources 110 may include end users of air filters in some embodiments. While shown with a single source 110, it will be appreciated that the system 100 may include any number of sources 110 in various embodiments.

The system 100 may include a recycling unit 115. The recycling unit 115 may be configured to take in a number of feedstocks and produce composite pellets having a desired composition. For example, the feedstocks may include waste materials from one or more sources 105 and/or sources 110. Depending on the form of waste, such feedstocks may include filter frames of air filters, air filtration media from air filters, and/or portions thereof. For example, the air filtration media may include a combination of glass and polymeric materials. For example, a carrier or backing of the air filtration media may include a thermoplastic material (such as, but not limited to, polyester, polystyrene, polyethylene terephthalate (PET), acrylonitrile butadiene styrene (ABS), nylon, other polyamides, polypropylene, and/or other thermoplastic material). In some embodiments, the thermoplastic materials of the carrier may form between 5% and 30% by weight of the filter sheet, with amounts of 10% to 20% by weight being more common. The air filtration media may include glass, such as glass microfibers, nanofibers, and/or other glass materials, which may be sprayed or otherwise applied to the thermoplastic carrier during formation of the air filtration media. The glass may include any type of glass, such as (but not limited to) E-glass, C-glass, S-glass, A-glass, AR-glass, and/or other forms of glass. In some embodiments, the glass fibers may include nano-sized (e.g., fibers having diameters of no greater than 1000 nm) and/or micro-sized (e.g., fibers having diameters of no greater than 1000 μm) fibers. The use of recycled nano-sized and/or micro-sized glass fibers may provide several benefits over the use of newly produced fibers. For example, nano-sized and/or micro-sized glass fibers are often difficult to handle, difficult to homogenously disperse in polymer matrices, and may be hazardous to handle. Nano materials are known to cause many toxicity issues. For example, nano materials may generate a large amount of dust that may cause inhalation issues. Additionally, due to the small size, nano materials may cause skin dermatitis and/or other issues. As the recycled fibers in the air filtration media are bound together and combined with polymeric materials, the glass fibers may be easier to handle and may produce less dust than virgin fibers that are provided in pure fiber form. Additionally, by using recycled glass fibers, the amount of wasted glass fibers may be reduced. Oftentimes, the fibers used in the air filtration media may be between 200 nm and 5.5 microns, however smaller or larger fibers are possible in various embodiments. The glass fibers may make up between 40% and 90% by weight of the air filtration media in some embodiments, and more commonly between 60% and 80% by weight. In some embodiments, the air filtration media may include a binder, such as a thermoplastic and/or thermoset resin (e.g., a phenol-based resin, a urea-based resin, a melamine-based resin, a formaldehyde-based resin, etc.), which may be used to bind the glass fibers to the carrier and/or to one another. The binder may be present in amounts of between 5% and 25% by weight of the air filtration media, with amounts of between 8% and 12% being more common.

The filter frame may include between 80% and 100% by weight of a thermoplastic material, more commonly between 85% and 95% by weight, which may be a same or different thermoplastic material as used in the filter sheets. For example, the filter frame may include a thermoplastic material (such as, but not limited to, polyester, polystyrene, polyethylene terephthalate (PET), acrylonitrile butadiene styrene (ABS), nylon, polyamides, polypropylene, and/or other thermoplastic material). In some embodiments, minor quantities of one or more additives may be included in the filter frame, such as in amounts of between 0% and 20% by weight of the filter frame. In some embodiments, the filter frame makes up between 50% and 90% (more commonly between 70% and 85%) by weight of the air filter, while the air filtration media make up between 10% and 30% by weight of the air filter. In such embodiments, thermoplastics may form between 70% and 95% of the weight of the air filter, while glass may form between 5% and 30% of the weight of the air filter. In some embodiments, one or more additional materials may form between 0% and 5% by weight of the air filter.

In some embodiments, such proportions may not be desired in the finished composite pellets. For example, higher or lower glass or thermoplastic concentrations may be desired and/or different thermoplastics and/or glasses may be included. In such embodiments, the recycling unit 115 may take in additional feedstocks, such as one or more thermoplastic materials and/or one or more glass materials. The thermoplastic materials may include a same and/or different thermoplastic than found in the air filtration waste. In some embodiments, the thermoplastic materials may include, without limitation, polyester, polystyrene, polyethylene terephthalate (PET), acrylonitrile butadiene styrene (ABS), nylon, polyamides, polypropylene, and/or other thermoplastic material. The thermoplastic feedstock may be provided in various forms, such as (but not limited to) pellets or other small pieces of one or more thermoplastic materials. In some embodiments, some or all of the thermoplastic feedstock may be recycled material. The relative proportions of the waste material and the thermoplastic feedstock may be dictated by the desired composition of the composite pellets and/or a relative composition of the air filters and/or other filtration waste. For example, where a greater proportion of thermoplastic is desired in the composite pellets than found in the air filters and/or other filtration waste, a greater percentage of the thermoplastic feedstock may be used. For example, in some embodiments, the thermoplastic feedstock may make up between 40% and 80% (more commonly between 40% and 60%) by weight of the material supplied to the recycling unit 115, while the air filters and/or waste makes up between 20% and 60% by weight of the material supplied to the recycling unit 115. In some embodiments, the composite pellets may include between 50% and 85% by weight of thermoplastic material and between 15% and 50% by weight of glass, with additives forming between 0% and 20% by weight of the composite pellets when present.

In some embodiments, the feedstocks may include one or more glass feedstocks. The glass feedstocks may be used, for example, to increase the glass content of the composite pellets when the waste materials do not include a sufficient amount of glass. The glass may be a same or different glass type than found in the air filtration waste. In some embodiments, the glass may include, without limitation, E-glass, C-glass, S-glass, A-glass, AR-glass, and/or other forms of glass. The glass feedstock may be provided in various forms such as (but not limited to) chopped waste glass, glass fibers, and/or other glass in small pieces. The relative proportions of the waste material and the glass feedstock may be dictated by the desired composition of the composite pellets. For example, where a greater proportion of glass is desired in the composite pellets, a greater percentage of the glass feedstock may be used. In some embodiments, the glass feedstock may make up between 0% and 40% by weight of the materials provided to the recycling unit 115.

In some embodiments, both a thermoplastic feedstock and a glass feedstock may be combined with the feedstock from the air filtration waste. This may be done, for example, where an additional type of type and/or amount of glass and/or thermoplastic material is desired. Various combinations of materials may be used to produce composite pellets of a desired composition.

While the pellets generated using system 100 may be usable in various injection molding and/or other manufacturing processes, due to the recycling process and/or the composition of the air filtration media and waste materials, some materials properties may be changed from those of the pure thermoplastic materials. For example, the tensile strength and/or flexural strength may be increased in some instances, while the impact strength may be reduced in various instances. In some embodiments, one or more additives that may be used to adjust one or more properties of the composite pellets, which may make the composite pellets more suitable for use in a given application. For example, additives may include, without limitation, one or more impact enhancers, antioxidants, polymeric chain extending agents, UV resistance modifiers, thermal stabilizers, coupling agents and/or sizing agents to enhance the compatibility between incompatible polymers and/or glass fibers, formaldehyde scavengers, and/or de-gassing agents. Suitable impact enhancers may include, for example, Dow Elvaloy™ PTW, Dow Elvaloy™ 4170, Kane Ace M300, Paraloid EXL 2690, Paraloid EXL 2650J, Paraloid EXL 2691J, Paraloid EXL 3691J, Lotader AX8900, Lotryl 29MA03T, and COACE W5AS. Suitable antioxidants may include, for example, hindered phenols, amines, phosphites, thiodipropionates, and/or metal salts. Suitable polymeric chain extending agents may include, for example, bisanhydrides, bisoxaolines, bisepoxides. It will be appreciated that any number of other additives may be included in various embodiments and multiple additives may be combined to generate composite pellets with properties that are suitable for a given fabrication application.

Certain binders, (e.g., urea-formaldehyde, melamine-formaldehyde, etc.) when reprocessed or heated can reform and off-gas formaldehyde and/or degrade into low molecular weight amines and other noxious compounds. Therefore, it may be advantageous to add various formaldehyde scavengers and/or de-gassing agents to reduce or eliminate these noxious compounds. Such scavengers and agents may include, for example, sulfamic acid, sodium sulfite, sodium bisulfite, calcium hydroxide, polyacrylamides, polyamines, sodium meta bisulfate, ammonium bisulfite, ammonium sulfate, carbohydrazides, resorcinols, acetoacetamide functional compounds, acetoacetoxy functional compounds, sodium sulfamate, ammonium sulfamate, e=diethylene triamine, ammonium bicarbonate, ammonium carbonate, thiourea, low molecular weight melamine resin, tetraethylene pentaamine, AMP (2-amino-2-methyl-1-propanol), AEPD (2-Amino-2-ethyl-1,3-propanediol), TRIS AMINO™ (Tris (hydroxymethyl)aminomethane), and/or other materials. The formaldehyde scavengers and/or de-gassing agents may be added at levels of between 0.1% and 5% by weight of other ingredients.

Condensation polymers are also susceptible to hydrolytic degradation if not pre-dried or if held at elevated temperatures in moist air for a long period of time. Condensation polymers may include any polymer in which monomers form together to create a polymer and a by-product, such as water or methanol. Condensation polymers may include, for example, polyesters and polyamides. The polymerization reaction is reversible; thus, condensation polymers must be pre-dried before processing. However, it is not preferable to dry or pre-dry the air filter or air filtration media before size reduction (e.g., chopping into smaller pieces) or extrusion processing. Therefore, it may be advantageous to add one or more chain extending additive compounds such as bisanhydrides, bisoxaolines, bisisocyanates, and/or bisepoxides which react with —OH or —COOH end groups caused by hydrolytic degradation. Chain extending additives may alternatively or additionally be added during melt processing to build molecular weight through ‘reactive extrusion’ or ‘reactive chain coupling’. Suitable chain extending agents for condensation polymers may include, but are not limited to, multifunctional (including, but not limited to, bifunctional) isocyanates, multifunctional epoxides, multifunctional silane, and/or multifunctional anhydrides.

In some embodiments, it may be advantageous that the chain extending additives also act as compatibilizers/coupling agents and provide enhance physical properties such as impact resistance. For instance, a silane functional elastomer or rubber-based copolymer may be used that can compatiblize polymers and also couple to glass fibers. Epoxy functional rubber and/or elastomer copolymers may be used that can chain extend and improve impact resistance.

Suitable chain extending agents may include, but are not limited to, copolymers of glycidyl methacrylate (GMA) with alkenes, copolymers of GMA with alkenes and acrylic esters, copolymers of GMA with alkenes and vinyl acetate, copolymers of GMA and styrene. Suitable alkenes may include ethylene, propylene, and mixtures of two or more of the foregoing. Suitable acrylic esters may include alkyl acrylate monomers, including, but not limited to, methyl acrylate, ethyl acrylate, propyl acrylate, butyl acrylate, and combinations of the foregoing alkyl acrylate monomers.

Illustrative examples of suitable chain extending agents may include ethylene-glycidyl acrylate copolymers, ethylene-glycidyl methacrylate copolymers, ethylene-glycidyl methacrylate-vinyl acetate copolymers, ethylene-glycidyl methacrylate-alkyl acrylate copolymers, ethylene-glycidyl methacrylate-methyl acrylate copolymers, ethylene-glycidyl methacrylate-ethyl acrylate copolymers, and ethylene-glycidyl methacrylate-butyl acrylate copolymers. Further, the glycidyl methacrylate in the foregoing examples may be substituted with silane functional methacrylate monomers such as methacryloxypropyl trimethoxysilane in some embodiments.

The recycling unit 115 may include a compounder 120 and a pelletizer 125 in some embodiments. The compounder 120 and pelletizer 125 may be separate machinery in some embodiments, however in some embodiments the compounder 120 and pelletizer 125 may be integrated into a single unit. The compounder 120 may receive and combine the various feedstocks and/or additives. For example, the feedstocks and/or additives may be supplied to one or more feeders (such as screw feeders) of the compounder 120, which may draw in the raw feedstock material and/or additives in a controlled manner to mix the materials into a desired blend for the composite. In some embodiments, the compounder 120 may include or be coupled with a chopping unit, which may be used to break the air filtration waste into smaller pieces prior to reaching the feeders.

The mixture of materials may be delivered to an extruder (which may be a portion of the pelletizer 125), where the various feedstocks and/or additives may be melted into a molten composite material that includes a mixture of each feedstock material and/or additive supplied to the extruder. The extruder may force the molten composite material through one or more dies to form a number of strands of the composite material, which may subsequently be cut to form composite pellets. The cutting may be performed using any number of techniques. For example, in some embodiments, the pelletizer 125 may be a strand pelletizer, an underwater pelletizer, and/or a hot-face cutting pelletizer. When the pelletizer 125 is a strand pelletizer, the strands of composite material emerging from the die are cooled and then cut into pellets by one or more blades, such as rotating blades. When the pelletizer 125 is an underwater pelletizer, the strands of composite material are submerged in water (or other solution) to cool and solidify after being into pellets. When the pelletizer 125 is a hot-face cutting pelletizer, the strands of composite material may be cut at the face of the die while the composite material is still hot. Regardless of the form of pelletizing used, the pelletizer 125 may cut the strands of composite material into smaller pellets of the composite material.

The composite pellets may be transported to a production tool 130, such an injection molding apparatus, which may use the composite pellets to form components for various products. For example, the production tool 130 may melt the composite pellets into a molten material that may be poured or otherwise positioned within a mold to form a new product or component thereof. Any type of product that may be produced using a combination of thermoplastic material and glass may be produced using the production tool 130. In a particular embodiment, the production tool 130 may be used to produce air filter frames that may hold air filtration medial to form air filters. After use, this air filters may be subsequently recycled in a similar manner, enabling the continuous recycling and reuse of air filters.

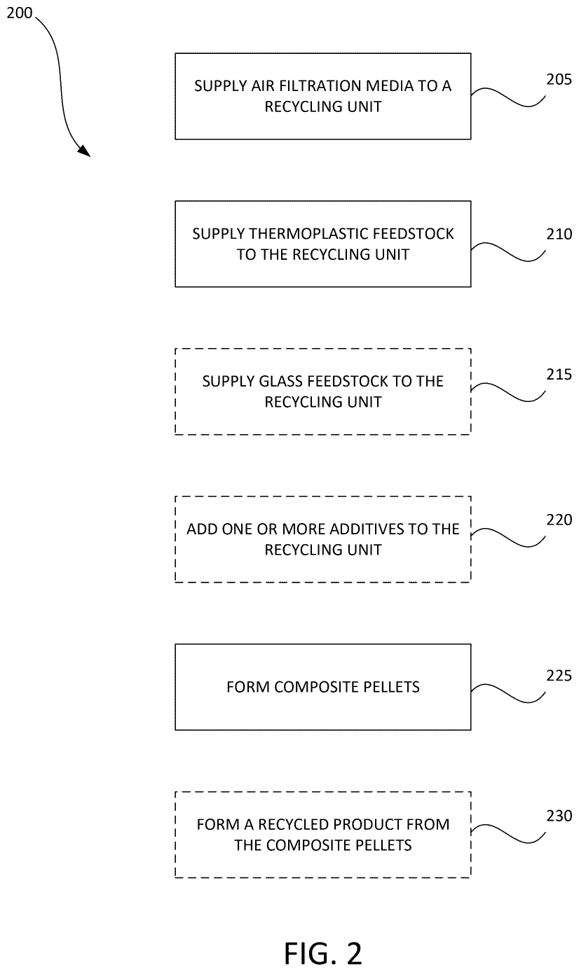

FIG. 2 illustrates a flowchart of a method 200 of recycling air filtration media according to embodiments of the present invention. Air filtration media may include air filters and/or portions thereof (e.g., filter frames and/or air filtration media), which may either be used materials and/or waste materials generated during the production of air filters and components thereof. The method 200 may utilize any of the components of the system 100 to recycle air filtration media. Additionally, method 200 may be used to produce new air filters or components thereof, such as components of air filter 300 described below. Method 200 may begin at operation 205 by supplying air filtration waste to a recycling unit (such as recycling unit 115). The air filtration waste may include used (e.g., discarded) air filters and/or portions thereof and/or waste generated during the production of the air filters. For example, the air filtration waste may be provided by one or more sources 105 waste from manufacturing air filters and/or air filtration media and/or one or more sources 110 of end of life or other used air filters that have since been replaced and discarded. The air filtration waste may include a thermoplastic material and glass. For example, filter frames from the sources 110 may include a thermoplastic material, while the air filtration media from sources 105 and/or 110 may include thermoplastic material from a carrier and/or binder, as well as glass fibers.

In some embodiments in which the air filtration waste includes used air filters, the method 200 may include rinsing or otherwise cleaning the air filters. For example, pressurized air may be blown against and through the air filtration media of the air filters to remove particulate trapped within the air filtration media. In some embodiments, the air filtration media may be exposed to water and/or other rinse solution that may help remove particulate from the air filtration media. For example, the air filtration media may be submerged within a bath of rinse solution and/or sprayed with the rinse solution. In some embodiments, the rinse solution and/or the air filtration media may be oscillated or otherwise moved to help better remove particulate from the air filtration media. In some embodiments, the air filtration waste may include between 0% and 10% by weight of contaminants, more preferably between 0% and 5% by weight of contaminants, when compounded (e.g., after rinsing and/or without a rinse operation).

The method 200 may include supplying a thermoplastic material to the recycling unit at operation 210. The thermoplastic material may be a thermoplastic feedstock that includes one or more thermoplastic materials. The thermoplastic feedstock may include, for example, polyester, polystyrene, polyethylene terephthalate (PET), acrylonitrile butadiene styrene (ABS), nylon, polyamides, polypropylene, and/or other thermoplastic material. The thermoplastic feedstock may include a same and/or different type of thermoplastic material than that found in the air filtration waste. In some embodiments, the thermoplastic feedstock may be provided in the form of pellets formed from a thermoplastic material, which may be a recycled thermoplastic material in some embodiments.

The method 200 may optionally include supplying glass material to the recycling unit at operation 215. The glass material may be a glass feedstock that includes one or more types of glass. For example, the glass feedstock may include, for example, E-glass, C-glass, S-glass, A-glass, AR-glass, and/or other forms of glass. The glass feedstock may include a same and/or different form of glass than that included in the air filtration waste. In some embodiments, the glass feedstock may include waste chopped glass and/or glass fibers.

At optional operation 220, the method 200 may include adding a number of additives to the recycling unit. The additives may be used to enhance or otherwise modify one or more properties of a resultant composite material formed by the method 200. The additives may include, without limitation, one or more impact enhancers, antioxidants, polymeric chain extending agents, UV resistance modifiers, thermal stabilizers, coupling agents and/or sizing agents to enhance the compatibility between incompatible polymers and/or glass fibers, formaldehyde scavengers, and/or de-gassing agents.

The relative amounts of thermoplastic feedstock, glass feedstock, and/or additives may be based on desired properties of a resultant composite material formed from the various materials. For example, based on an intended end use of the composite pellets, one or more desired properties of the composite material may be determined. For example, the intended end use may include a particular product or component thereof that may be formed from the composite pellets. Each product may require specific material properties to be used in a particular application in a satisfactory manner. Based on these desired properties, relative types and/or amounts of the thermoplastic feedstock, the glass feedstock, and/or additives supplied to the recycling unit may be adjusted. In a particular embodiment, the air filtration waste may make up between 40% and 60% by weight of the materials supplied to the recycling unit such that the composite pellets are made up of between 40% and 60% by weight of the air filtration waste, although other amounts of the air filtration waste are possible in various embodiments. The thermoplastic feedstock, the glass feedstock, and/or any additives may make up the remaining portion of the materials supplied to the recycling unit. For example, the thermoplastic feedstock, glass feedstock, and/or additives may be provided in quantities of between 40% and 60% by weight and may be present in similar quantities in the composite pellets. In embodiments in which no glass or additives are included, the materials and composite pellets may include between 40% and 60% by weight of the air filtration waste and between 40% and 60% by weight of the thermoplastic feedstock. In such embodiments, the final composite pellets may include between 20% and 40% by weight of glass from the air filtration waste. When present, the glass feedstock may often be present in quantities of between 5% and 60% by weight. Where present, the various additives may each be present in quantities of between 0.5% and 10% by weight and may collectively form between 0.5% and 40% by weight of the composite material. It will be appreciated that the quantities described above are merely provided as examples and that numerous variations exist as the composite material may be tailored to meet the material properties needed for a particular end use product or component.

At operation 225, a number of composite pellets may be formed from the various feedstocks and additives provided to the recycling unit. For example, the composite pellets may include material from the air filtration waste, the thermoplastic feedstock, the glass feedstock, and/or any additives that have been introduced into the recycling unit. Forming the composite pellets may include, for example, breaking down the air filtration waste into smaller pieces of air filtration waste. For example, the air filtration waste may be introduced into a chopper or other mechanism that may chop or otherwise break down the larger pieces of air filtration waste (e.g., frames, air filtration media, etc.) into smaller pieces that may facilitate more homogenous mixing of the air filtration waste with other feedstock and/or additives. When mixed, the air filtration waste, the various thermoplastic and/or glass feedstock, and/or any additives may be melted together to form a melted composite material. The melted composite material may be extruded through one or more dies to form a number of strands of the composite material. These strands may be chopped or otherwise cut to form composite pellets.

The composite pellets may include small pieces of relatively uniform sizes and shapes. The diameter and/or length of the composite pellets may be adjusted to meet the needs of a particular application. For example, a die may be selected to have an aperture size that corresponds with a desired pellet diameter, while a rotation speed and/or other frequency of one or more blades or other chopping mechanisms may be adjusted to control a length of each composite pellet. The composite pellets may have any diameter and/or length that may facilitate injection molding and/or other manufacturing processes using the composite material.

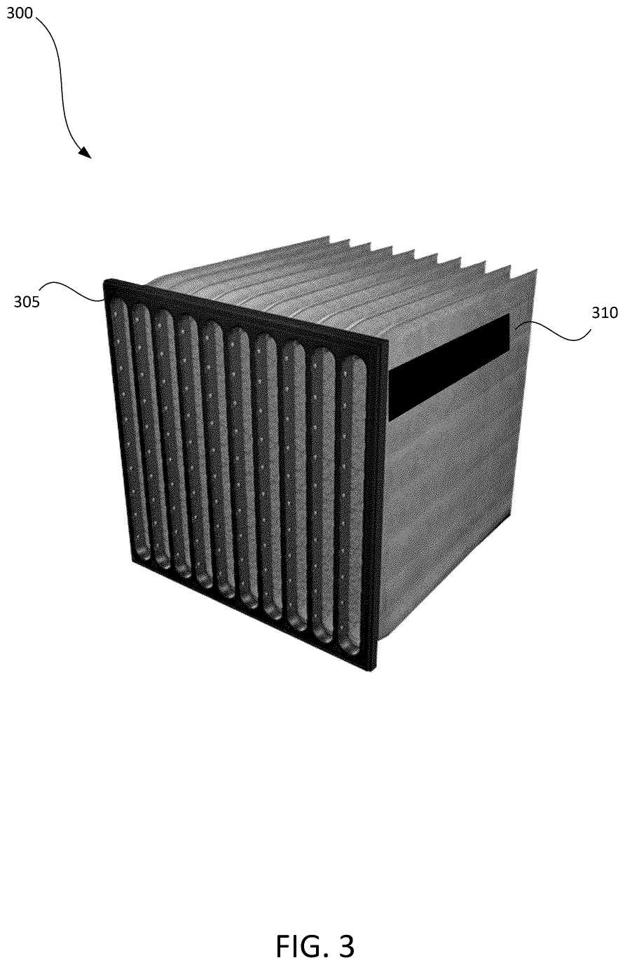

At optional operation 230, method 200 may include forming a recycled product using at least some of the composite pellets. For example, the composite pellets may be transported to a production tool, such as an injection molding apparatus. The production tool may melt the pellets into a molten state and may introduce the molten composite material into a number of molds for forming various thermoplastic products and/or components thereof. In a particular embodiment, the molds may be for frames for air filtration waste, such as those illustrated and described in relation to FIG. 3 below. However, it will be appreciated that the composite pellets formed using method 200 may be utilized to form any number of types of thermoplastic products and/or components in various embodiments.

The composite pellets formed by method 200 may have various properties, depending on the feedstocks used to produce the pellets. For example, based on different types of thermoplastics and/or quantities thereof, the resultant composite pellets may have different properties as illustrated in Table 1 below.

TABLE 1

| Mechanical | Filter | Filter | Filter |
|---|---|---|---|
| Property | Media + rPET* | Media + ABS* | Frame + PET* |
| Tensile | 70-80 | 45-55 | 30-40 |
| Strength | MPa | MPa | MPa |
| (ISO 527-2) | | | |
| Flexural | 100-120 | 45-50 | 35-45 |
| Strength | MPa | MPa | MPa |
| (ISO 178) | | | |
| Charpy | 15-20 | 15-20 | 15-20 |
| Impact | kJ/m2 | kJ/m2 | kJ/m2 |
| (ISO 179-1) | | | |
| Young's | 5500-6200 | 4500-5000 | 4000-4800 |
| Modulus | MPa | MPa | MPa |
| MFI | 70-80 g/10 min | 25-27 g/10 min | 5-6 g/10 min |
| (ISO 1133) | | | |
| Glass | 27-28% | 26-28% | 12-13% |
| Content | | | |

It will be appreciated that the various properties of the composite pellets may be augmented via the inclusion of one or more additives and/or by changing the type and/or relative proportions of thermoplastic and/or glass feedstocks used to produce the composite pellets.

FIG. 3 illustrates an air filter 300 according to some embodiments of the present technology. The air filter 300 may be similar to those that may be recycled using recycling unit 115. The air filter 300 may include a frame 305, which may be formed from a thermoplastic and/or thermoplastic/glass composite material. In some embodiments, the frame 305 may be formed from composite material formed from the recycling unit 115. For example, the frame 305 may be formed using a production unit 130 by melting composite pellets from the recycling unit 115 and supplying the molten composite material to a mold to form the frame 305. The frame 305 may be sized and shaped to support one or more air filtration media 310. The air filtration media 310 may include a thermoplastic material and a glass material, which may be combined to form a filter for the air filter 300. For example, the air filtration media 310 may include a carrier formed from a thermoplastic, such as (but not limited to) a spunbond polyester). The carrier may include, for example mesh like fabric. Glass fibers may be blown and/or otherwise applied to one or more surfaces of the carrier to form the air filtration media 310. In some embodiments, the air filtration media 310 may be pleated. Any number of air filtration media 310 and/or pleats may be included in a given air filter 300, and the air filter 300 may have any dimensions to meet the needs of a particular application. The frame 305 may form between 50% and 90% by weight of the air filter 300, which may also include air filtration media 310 forming between 10% and 30% by weight of the air filter 300. In some embodiments, additional materials may form between 0% and 5% by weight of the air filter 300.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of recycling air filtration waste, comprising:
supplying air filtration waste to a recycling unit, the air filtration waste comprising a first thermoplastic material and glass;
supplying a second thermoplastic material to the recycling unit; and
forming a plurality of composite pellets from the air filtration waste and the second thermoplastic material using the recycling unit, the plurality of composite pellets comprising a mixture of the first thermoplastic material, the second thermoplastic material, and the glass.

2. The method of recycling air filtration waste of claim 1, wherein:
the air filtration waste comprises one or both of used air filters and waste from a process for fabricating air filters.

3. The method of recycling air filtration waste of claim 1, wherein:
the second thermoplastic material comprises recycled thermoplastic material.

4. The method of recycling air filtration waste of claim 1, wherein:
the second thermoplastic material comprises a plurality of pellets formed from the second thermoplastic material.

5. The method of recycling air filtration waste of claim 1, wherein:
the first thermoplastic material and the second thermoplastic material are a same material.

6. The method of recycling air filtration waste of claim 1, further comprising:
adding one or more additives to the recycling unit, wherein the plurality of composite pellets further comprise the one or more additives.

7. The method of recycling air filtration waste of claim 6, wherein:
the one or more additives comprise at least one of an impact enhancer, UV modifier, or de-gassing agent.

8. A method of recycling air filtration waste, comprising:
supplying air filtration waste to a recycling unit, the air filtration waste comprising a first thermoplastic material and glass;
supplying a second thermoplastic material to the recycling unit;
forming a plurality of composite pellets from the air filtration waste and the second thermoplastic material using the recycling unit, the plurality of composite pellets comprising a mixture of the first thermoplastic material, the second thermoplastic material, and the glass; and
forming a recycled product using at least some of the plurality of composite pellets.

9. The method of recycling air filtration waste of claim 8, further comprising:
determining one or more desired properties of the plurality of composite pellets; and
adjusting amount of the second thermoplastic material supplied to the recycling unit based on the one or more desired properties.

10. The method of recycling air filtration waste of claim 8, wherein:
the recycled product comprises a frame of an air filter.

11. The method of recycling air filtration waste of claim 10, wherein:
forming the recycled product comprises using injection molding to form the frame from the at least some of the plurality of composite pellets.

12. The method of recycling air filtration waste of claim 8, further comprising:
cleaning the air filtration waste prior to forming the plurality of composite pellets.

13. The method of recycling air filtration waste of claim 10, wherein:
the air filtration waste forms between 40% and 60% by weight of materials supplied to the recycling unit; and
the second thermoplastic material forms between 40% and 60% by weight of materials supplied to the recycling unit.

14. The method of recycling air filtration waste of claim 8, wherein:
the plurality of composite pellets comprise between 20% and 40% by weight of the glass.

15. A method of recycling air filtration waste, comprising:
supplying of air filtration waste to a recycling unit, the air filtration waste comprising a first thermoplastic material and glass;
supplying a second thermoplastic material to the recycling unit;
forming a plurality of composite pellets from the f air filtration waste and the second thermoplastic material using the recycling unit, the plurality of composite pellets comprising a mixture of the first thermoplastic material, the second thermoplastic material, and the glass, wherein forming the plurality of composite pellets comprises:
breaking down the plurality of air filtration waste into pieces of air filtration waste;
melting the pieces of air filtration waste and the second thermoplastic material to form a melted composite material;
extruding the melted composite material to form a plurality of strands of composite material; and
chopping the plurality of strands of composite material to form the plurality of composite pellets.

16. The method of recycling air filtration waste of claim 15, further comprising:
supplying a glass material to the recycling unit.

17. The method of recycling air filtration waste of claim 16, wherein:
the glass from the air filtration waste and the glass material are a same form of glass.

18. The method of recycling air filtration waste of claim 16, wherein:
the glass material comprises one or both of waste chopped glass and glass fibers.

19. The method of recycling air filtration waste of claim 15, wherein:
the first thermoplastic material and the second thermoplastic material are different materials.

20. The method of recycling air filtration waste of claim 15, wherein:
the recycling unit comprises a compounder and a pelletizer.
